(19) United States
(12) Patent Application Publication
(10) Pub. No.: US 2010/0214702 A1
(43) Pub. Date: Aug. 26, 2010

(54) OVER-CURRENT PROTECTION CIRCUIT AND MOTOR CONTROLLER COMPRISING THE SAME

(75) Inventors: Yong ZHAO, Zhongshan (CN); Junqiang ZHANG, Zhongshan (CN); Dawei LIU, Zhongshan (CN); Songfa TANG, Zhongshan (CN)

Correspondence Address: MATTHIAS SCHOLL, 14781 MEMORIAL DRIVE, SUITE 1319, HOUSTON, TX, 77079, US

(73) Assignee: ZHONGSHAN BROAD-OCEAN MOTOR CO., LTD., Zhongshan (CN)

(21) Appl. No.: 12/638,979

(22) Filed: Dec. 15, 2009

(30) Foreign Application Priority Data
Feb. 24, 2009 (CN) 200920051889.0

(51) Int. Cl. H02H 7/085

(52) U.S. Cl. 361/31

(57) ABSTRACT

An over-current protection circuit, has a main transmission circuit including at least a first triode and a first resistor, a trigger circuit including a second triode and a second resistor, and a detecting circuit having an input terminal and an output terminal. One end of the first resistor is connected to one end of a collecting electrode and an emitting electrode of the first triode. The other end of the first resistor is connected to a current output. The other end of the collecting electrode and the emitting electrode of the first triode is connected to a current input. One end of the second resistor is connected to a collecting electrode of the second triode. The other end of the second resistor is connected to the ground. An emitting electrode of the second triode is connected to the current input. The collecting electrode of the second triode is connected to a base electrode of the first triode. The input terminal of the detecting circuit is connected to the current output whereby extracting a detecting signal therefrom. The output terminal of the detecting circuit is connected to a base electrode of the second triode

### CROSS-REFERENCE TO RELATED APPLICATIONS

Pursuant to 35 U.S.C. §119 and the Paris Convention Treaty, this application claims the benefit of Chinese Patent Application No. 200920051889.0 filed on Feb. 24, 2009, the contents of which are incorporated herein by reference.

### BACKGROUND OF THE INVENTION

1. Field of the Invention

The invention relates to an over-current protection circuit and a motor controller comprising the same.

2. Description of the Related Art

Over-current protection circuits are widely used in current DC power supplies. Conventional over-current protection circuits use fuses, positive temperature coefficient (PTC) thermistors, switches or transistors. However, there are several problems with the over-current protection circuit: the fuse cannot be reused, the thermistor and the switch are expensive and unsuitable for circuits with a small or large current, and the transistor features a complex structure and high cost, and a limited over-current protection range.

### SUMMARY OF THE INVENTION

In view of the above-described problem, it is one objective of the invention to provide an over-current protection circuit that features a simple structure, low cost, high reliability, and a wide over-current protection range.

It is another objective of the invention to provide a motor controller that features a simple structure, low cost, high reliability, and a wide over-current protection range.

To achieve the above objectives, in accordance with one embodiment of the invention, provided is an over-current protection circuit, comprising a main transmission circuit comprising a first triode and a first resistor, a trigger circuit comprising a second triode and a second resistor, and a detecting circuit having an input terminal and an output terminal. One end of the first resistor is connected to an emitting electrode of the first triode, the other end of the first resistor is connected to a current output, the collecting electrode of the first triode is connected to a current input, one end of the second resistor is connected to a collecting electrode of the second triode, the other end of the second resistor is connected to the ground, an emitting electrode of the second triode is connected to the current input, the collecting electrode of the second triode is connected to a base electrode of the first triode, the input terminal of the detecting circuit is connected to the current output whereby extracting a detecting signal therefrom, and the output terminal of the detecting circuit is connected to a base electrode of the second triode.

In a class of this embodiment, the first resistor is a variable resistor.

In a class of this embodiment, the detecting circuit comprises a third resistor, a fourth resistor, and a fifth resistor.

In a class of this embodiment, one end of each of the third resistor, the fourth resistor, and the fifth resistor are connected altogether.

In a class of this embodiment, the other end of the fifth resistor is connected to the current output, the other end of the fourth resistor is connected to the current input, and the other end of the third resistor is connected to the base electrode of the second triode.

According to another embodiment of the invention, provided is an over-current protection circuit, comprising a main transmission circuit comprising a first triode, a trigger circuit comprising a second triode and a second resistor, and a detecting circuit having an input terminal and an output terminal and comprising a first resistor. One end of the first resistor is connected to an emitting electrode of the first triode, the other end of the first resistor is connected to a current output, the collecting electrode of the first triode is connected to a current input, one end of the second resistor is connected to a collecting electrode of the second triode, the other end of the second resistor is connected to the current input, an emitting electrode of the second triode is connected to the current output, the collecting electrode of the second triode is connected to a base electrode of the first triode, the input terminal of the detecting circuit is connected to the current output whereby extracting a detecting signal therefrom, and the output terminal of the detecting circuit is connected to a base electrode of the second triode.

In a class of this embodiment, the first resistor is a variable resistor, and the other end of the first resistor is connected to the base electrode of the second triode.

Advantages of the over-current protection circuit of the invention comprise: 1) it can be used in various controllers and features a wide over-current protection range from several microampere grade to tens ampere; 2) it has a small size, a simple structure, high reliability, and low cost; 3) it features less heat radiation, low temperature rise, good adaptability and increases service time of the motor controller.

According to a further embodiment of the invention, provided is a motor controller, comprising a power supply, and an over-current protection circuit, comprising a main transmission circuit comprising a first triode and a first resistor, a trigger circuit comprising a second triode and a second resistor, and a detecting circuit having an input terminal and an output terminal. The power supply is connected to the over-current protection circuit, one end of the first resistor is connected to an emitting electrode of the first triode, the other end of the first resistor is connected to a current output, the collecting electrode of the first triode is connected to a current input, one end of the second resistor is connected to a collecting electrode of the second triode, the other end of the second resistor is connected to the ground, an emitting electrode of the second triode is connected to the current input, the collecting electrode of the second triode is connected to a base electrode of the first triode, the input terminal of the detecting circuit is connected to the current output whereby extracting a detecting signal therefrom, and the output terminal of the detecting circuit is connected to a base electrode of the second triode.

In a class of this embodiment, the first resistor is a variable resistor.

In a class of this embodiment, the detecting circuit comprises a third resistor, a fourth resistor, and a fifth resistor.

In a class of this embodiment, one end of each of the third resistor, the fourth resistor, and the fifth resistor are connected altogether.

In a class of this embodiment, the other end of the fifth resistor is connected to the current output, the other end of the fourth resistor is connected to the current input, and the other end of the third resistor is connected to the base electrode of the second triode.

According to a still further embodiment of the invention, provided is a motor controller, comprising a power supply, and an over-current protection circuit, comprising a main transmission circuit comprising a first triode, a trigger circuit comprising a second triode and a second resistor, and a detecting circuit having an input terminal and an output terminal and comprising a first resistor. The power supply is connected to the over-current protection circuit, one end of the first resistor is connected to an emitting electrode of the first triode, the other end of the first resistor is connected to a current output, the collecting electrode of the first triode is connected to a current input, one end of the second resistor is connected to a collecting electrode of the second triode, the other end of the second resistor is connected to the current input, an emitting electrode of the second triode is connected to the current output, the collecting electrode of the second triode is connected to a base electrode of the first triode, the input terminal of the detecting circuit is connected to the current output whereby extracting a detecting signal therefrom, and the output terminal of the detecting circuit is connected to a base electrode of the second triode.

In a class of this embodiment, the first resistor is a variable resistor, and the other end of the first resistor is connected to the base electrode of the second triode.

Advantages of the motor controller of the invention comprise: 1) it features a wide over-current protection range from several microampere grade to tens ampere; 2) it has a small size, a simple structure, high reliability, and low cost; 3) it features less heat radiation, low temperature rise, good adaptability and improves reliability of the motor controller.

### BRIEF DESCRIPTION OF THE DRAWINGS

The invention is described hereinafter with reference to accompanying drawings, in which:

FIG. 1 is a block diagram of an over-current protection circuit of an embodiment of the invention;

FIG. 2 is a schematic diagram of an over-current protection circuit of an embodiment of the invention;

FIG. 3 is a block diagram of an over-current protection circuit of another embodiment of the invention;

FIG. 4 is a schematic diagram of an over-current protection circuit of another embodiment of the invention; and

FIG. 5 is a block diagram of a motor controller of an embodiment of the invention.

### DETAILED DESCRIPTION OF THE EMBODIMENTS

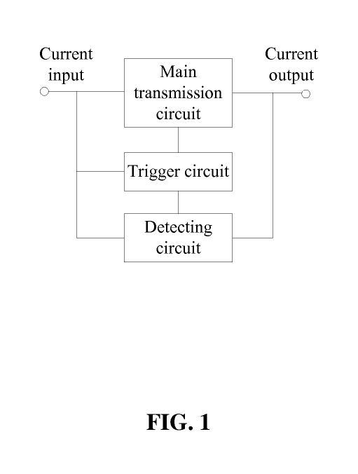

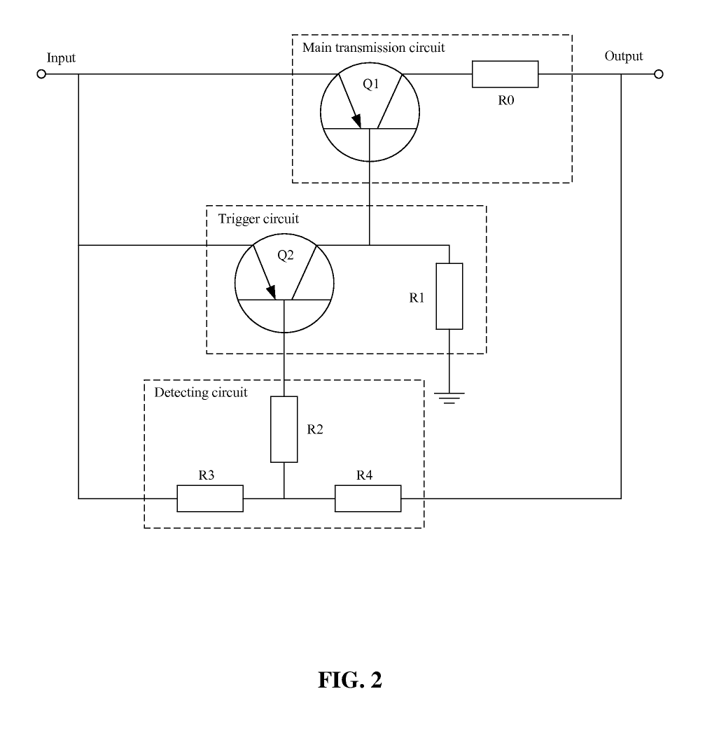

As shown in FIGS. 1 and 2, an over-current protection circuit of the invention comprises a main transmission circuit, a trigger circuit, and a detecting circuit.

The main transmission circuit comprises a first triode Q1 and a first resistor R0. One end of the first resistor R0 is connected to an emitting electrode of the first triode Q1, the other end of the first resistor R0 is connected to a current output, and the collecting electrode of the first triode Q1 is connected to a current input. In this embodiment, the first resistor R0 is a variable resistor.

The trigger circuit comprises a second triode Q2 and a second resistor R1. One end of the first resistor R1 is connected to a collecting electrode of the second triode Q2, and the other end of the first resistor R1 is connected to the ground. An emitting electrode of the second triode Q2 is connected to the current input, and the collecting electrode of the second triode Q2 is connected to a base electrode of the first triode Q1.

The detecting circuit has an input terminal and an output terminal, and comprises a third resistor R2, a fourth resistor R3, and a fifth resistor R4, one end of each of the third resistor R2, the fourth resistor R3, and the fifth resistor R4 are connected altogether, the other end of the fifth resistor R4 is connected to the current output, the other end of the fourth resistor R3 is connected to the current input, and the other end of the third resistor R2 is connected to the base electrode of the second triode R2. The input terminal of the detecting circuit is connected to the current output whereby extracting a detecting signal therefrom, and the output terminal of the detecting circuit is connected to a base electrode of the second triode Q2.

Operation principle of the over-current protection circuit is: An allowable maximum current is determined by the first resistor R0. Current from the current input flows through the emitting electrode and the collecting electrode of the first triode Q1 and the first resistor R0 and is output via the current output, at this time the second triode Q2 is off. As the current is increased to an allowable maximum value determined by the first resistor R0 and a voltage drop between both ends of the first resistor is large enough, voltage of the current output is reduced, and a voltage drop between the emitting electrode and the base electrode of the second triode Q2 is increased and the second triode Q2 is on, which increases a potential at the collecting electrode of the second triode Q2 and a voltage at the base electrode of the first electrode Q1, and thus the first electrode Q1 is off and stops outputting current whereby limiting current output.

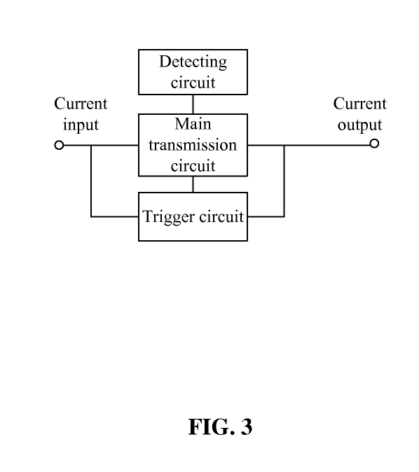

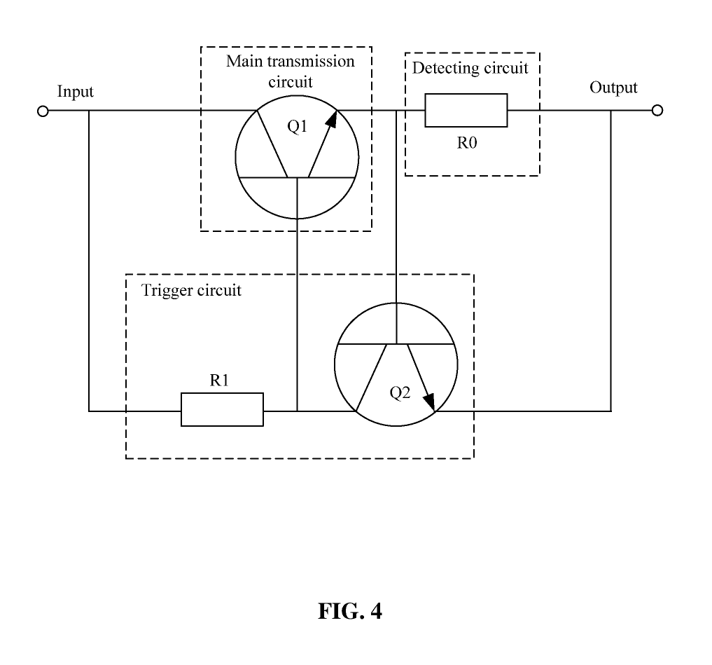

As shown in FIGS. 3 and 4, another over-current protection circuit of the invention comprises a main transmission circuit, a trigger circuit, and a detecting circuit.

The main transmission circuit comprises a first triode Q1.

The trigger circuit comprises a second triode Q2 and a first resistor R0. One end of the first resistor R0 is connected to a collecting electrode of the second triode Q2, the other end of the first resistor R0 is connected to the current input. An emitting electrode of the second triode Q2 is connected to the current output, and the collecting electrode of the second triode Q2 is connected to a base electrode of the first triode Q1.

The detection circuit has an input terminal and an output terminal and comprises a first resistor R0. One end of the first resistor RO is connected to an emitting electrode of the first triode Q1, the other end of the first resistor R0 is connected to a current output. The collecting electrode of the first triode Q1 is connected to a current input. The input terminal of the detecting circuit is connected to the current output whereby extracting a detecting signal therefrom, and the output terminal of the detecting circuit is connected to a base electrode of the second triode Q2.

Operation principle of the over-current protection circuit is: Current from the current input flows through the emitting electrode and the collecting electrode of the first triode Q1 and the first resistor RO and is output via the current output, at this time the second triode Q2 is off. As the current is increased to an allowable maximum value determined by the first resistor RO and a voltage drop between both ends of the first resistor is large enough, voltage of the current output is reduced, and a voltage drop between the emitting electrode and the base electrode of the second triode Q2 is increased and the second triode Q2 is on, which increases a potential at the collecting electrode of the second triode Q2 and a voltage at the base electrode of the first electrode Q1, and thus the first electrode Q1 is off and stops outputting current whereby limiting current output.

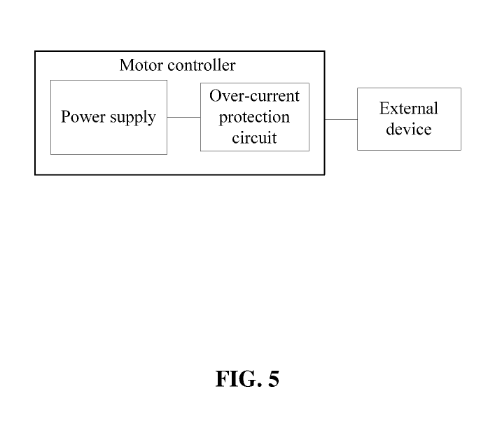

As shown in FIG. 5, a motor controller of the invention comprises a power supply and an over-current protection circuit connected with each other, and the over-current protection circuit is connected to an external device such as a programming device.

Structure and operation principle of the over-current protection circuit are the same as above with reference to FIGS. 1-4, and will not be described hereinafter any longer.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An over-current protection circuit, comprising
a main transmission circuit comprising a first triode and a first resistor;
a trigger circuit comprising a second triode and a second resistor; and
a detecting circuit having an input terminal and an output terminal; wherein
one end of said first resistor is connected to an emitting electrode of said first triode;
the other end of said first resistor is connected to a current output;
said collecting electrode of said first triode is connected to a current input;
one end of said second resistor is connected to a collecting electrode of said second triode;
the other end of said second resistor is connected to the ground;
an emitting electrode of said second triode is connected to the current input;
said collecting electrode of said second triode is connected to a base electrode of said first triode;
said input terminal of said detecting circuit is connected to the current output whereby extracting a detecting signal therefrom; and
said output terminal of said detecting circuit is connected to a base electrode of said second triode.

2. The over-current protection circuit of claim 1, wherein said first resistor is a variable resistor.

3. The over-current protection circuit of claim 1, wherein said detecting circuit comprises a third resistor, a fourth resistor, and a fifth resistor.

4. The over-current protection circuit of claim 3, wherein one end of each of said third resistor, said fourth resistor, and said fifth resistor are connected altogether.

5. The over-current protection circuit of claim 3, wherein
the other end of said fifth resistor is connected to the current output;
the other end of said fourth resistor is connected to the current input; and
the other end of said third resistor is connected to said base electrode of said second triode.

6. An over-current protection circuit, comprising
a main transmission circuit comprising a first triode;
a trigger circuit comprising a second triode and a second resistor; and
a detecting circuit having an input terminal and an output terminal and comprising a first resistor;
wherein
one end of said first resistor is connected to an emitting electrode of said first triode;
the other end of said first resistor is connected to a current output;
said collecting electrode of said first triode is connected to a current input;
one end of said second resistor is connected to a collecting electrode of said second triode;
the other end of said second resistor is connected to the current input;
an emitting electrode of said second triode is connected to the current output;
said collecting electrode of said second triode is connected to a base electrode of said first triode;
said input terminal of said detecting circuit is connected to the current output whereby extracting a detecting signal therefrom; and
said output terminal of said detecting circuit is connected to a base electrode of said second triode.

7. The over-current protection circuit of claim 6, wherein
said first resistor is a variable resistor; and
the other end of said first resistor is connected to said base electrode of said second triode.

8. A motor controller, comprising
a power supply; and
an over-current protection circuit, comprising
a main transmission circuit comprising a first triode and a first resistor;
a trigger circuit comprising a second triode and a second resistor; and
a detecting circuit having an input terminal and an output terminal;
wherein
said power supply is connected to said over-current protection circuit;
one end of said first resistor is connected to an emitting electrode of said first triode;
the other end of said first resistor is connected to a current output;
said collecting electrode of said first triode is connected to a current input;
one end of said second resistor is connected to a collecting electrode of said second triode;
the other end of said second resistor is connected to the ground;
an emitting electrode of said second triode is connected to the current input;
said collecting electrode of said second triode is connected to a base electrode of said first triode;
said input terminal of said detecting circuit is connected to the current output whereby extracting a detecting signal therefrom; and
said output terminal of said detecting circuit is connected to a base electrode of said second triode.

9. The motor controller of claim 8, wherein said first resistor is a variable resistor.

10. The motor controller of claim 8, wherein said detecting circuit comprises a third resistor, a fourth resistor, and a fifth resistor.

11. The motor controller of claim 10, wherein one end of each of said third resistor, said fourth resistor, and said fifth resistor are connected altogether.

12. The motor controller of claim 10, wherein
the other end of said fifth resistor is connected to the current output;
the other end of said fourth resistor is connected to the current input; and
the other end of said third resistor is connected to said base electrode of said second triode.

13. A motor controller, comprising
a power supply; and
an over-current protection circuit, comprising
a main transmission circuit comprising a first triode;
a trigger circuit comprising a second triode and a second resistor; and
a detecting circuit having an input terminal and an output terminal and comprising a first resistor;
wherein
said power supply is connected to said over-current protection circuit;
one end of said first resistor is connected to an emitting electrode of said first triode;
the other end of said first resistor is connected to a current output;
said collecting electrode of said first triode is connected to a current input;
one end of said second resistor is connected to a collecting electrode of said second triode;
the other end of said second resistor is connected to the current input;
an emitting electrode of said second triode is connected to the current output;
said collecting electrode of said second triode is connected to a base electrode of said first triode;
said input terminal of said detecting circuit is connected to the current output whereby extracting a detecting signal therefrom; and
said output terminal of said detecting circuit is connected to a base electrode of said second triode.

14. The motor controller of claim 13, wherein
said first resistor is a variable resistor; and
the other end of said first resistor is connected to said base electrode of said second triode.
